(19) United States
(12) Patent Application Publication
(10) Pub. No.: US 2024/0283279 A1
(43) Pub. Date: Aug. 22, 2024

(54) SYSTEM COMBINING EXERCISE, WORK, POWER GENERATION AND ENERGY STORAGE

(71) Applicant: STRENGTH MASTER FITNESS TECH CO., LTD., CHANGHUA COUNTY (TW)

(72) Inventor: SHU YAO WU, CHANGHUA COUNTY (TW)

(21) Appl. No.: 18/172,636

(22) Filed: Feb. 22, 2023

(51) Int. Cl. H02J 7/14; A63B 22/06; H02K 7/14

(52) U.S. Cl. CPC H02J 7/1469; A63B 22/0605; H02K 7/14; A63B 2022/0635

(57) ABSTRACT

A system combining exercise, work, power generation and energy storage has a rotary power generation device, disposed in an exercise apparats for converting rotational kinetic energy into electric energy; an energy storage device for storing the electric energy; a charging port, disposed on the exercise apparats; a resistor, configured to supply resistance power, a monitoring unit, configured to display data of the kinetic energy and the electric energy; and a control system for managing or controlling the electric energy, so as to adjust a charging electric energy demand of the charging port, the electric energy stored by the energy storage device, and the resistance value of stepping by the user according to the resistance setting of the monitoring unit.

### FIELD OF THE INVENTION

The present invention relates to a power generation device, and more particularly to a system combining exercise, work, power generation and energy storage.

### BACKGROUND OF THE INVENTION

For general exercise and fitness machines, such as a flywheel, the resistance to rotation when the user steps on the exercise machine can be adjusted through a resistance setting device, such that the user can adjust a desired exercise intensity.

In order not to waste the kinetic energy generated by doing exercise, a conventional exercise machine may be equipped with an energy storage device for converting the kinetic energy generated by the user's exercise into electric energy for storage, so as to supply power to other equipment for operation.

However, the conventional exercise machine lacks a management system, and cannot integrate the relationship between resistance and power generation, the usage of the stored power and the exercise efficiency and monitor the data, so it needs to be improved.

### SUMMARY OF THE INVENTION

The primary object of the present invention is to provide a system combining exercise, work, power generation and energy storage. The user can do exercise while working. The system is equipped with an energy storage device for energy storage and power generation, so as to achieve a management system that integrates the relationship between resistance and power generation, the usage of the stored power and the user's exercise efficiency.

In order to achieve the foregoing object, the present invention provides a system combining exercise, work, power generation and energy storage. The system is disposed on an exercise apparatus. The system comprises a seat, a workbench, a rotary power generation device, an energy storage device, a charging port, a monitoring unit, and a control system. The workbench is disposed in front of the seat. The rotary power generation device is disposed in the exercise apparats for converting rotational kinetic energy into electric energy. The energy storage device is electrically connected to the rotary power generation device for storing the electric energy converted by the rotary power generation device. The charging port is disposed on the exercise apparats or the workbench for providing a charging interface. (The charging port is configured to supply power to the energy storage device or an electrical product.) The monitoring unit is configured to provide an operation interface and display data of the kinetic energy and the electric energy. The control system is electrically connected to the rotary power generation device, the energy storage device, the charging port, the monitoring unit and a resistor for managing or controlling the electric energy, so as to adjust a charging electric energy demand of the charging port, the electric energy stored by the energy storage device, and a resistance power of the resistor according to a resistance setting value of the monitoring unit, that is, to adjust the rotational resistance value for the user to pedal the exercise apparatus. The purpose of generating electricity, storing energy and keeping the resistance value of pedaling the exercise apparatus can be achieved by means of the control system.

Preferably, the energy storage device is detachably disposed in the exercise apparatus and receives power through the charging port of the exercise apparatus.

Preferably, the monitoring unit has an operation panel. The energy storage device is electrically connected to the monitoring unit to supply power to the operation panel for operation.

Preferably, the control system converts a rotational resistance value of the exercise apparatus into an estimated power generation datum.

Preferably, the monitoring unit is connected to the exercise apparatus for reading and recording exercise data, connected to the energy storage device for reading and recording electric energy storage data, and connected to the control system for reading and recording resistance adjustment data and estimated power generation data.

Preferably, the workbench is fixedly or moveably connected to the exercise apparatus.

Preferably, the resistor supplies resistance power and is electrically connected to the rotary power generation device. The control system is electrically connected to the resistor. A resistance value of the resistor is adjusted by the control system to set the rotational resistance value of the exercise apparatus.

### BRIEF DESCRIPTION OF THE DRAWINGS

FIG. 1 is a perspective view of the present invention;

FIG. 2 is a block diagram of the present invention; and

FIG. 3 is a schematic view of another embodiment of the present invention.

### DETAILED DESCRIPTION OF THE PREFERRED EMBODIMENTS

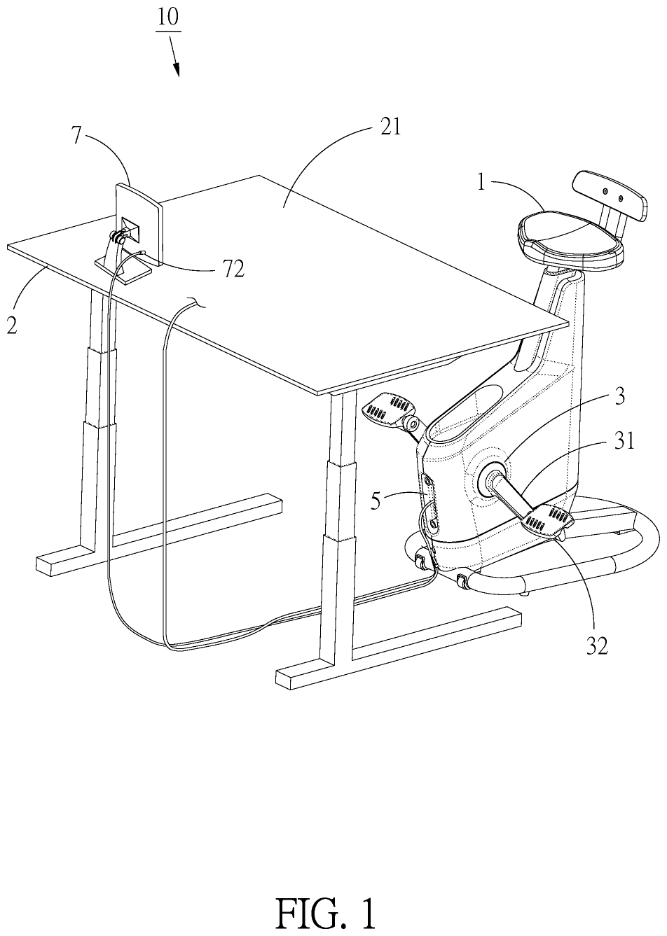

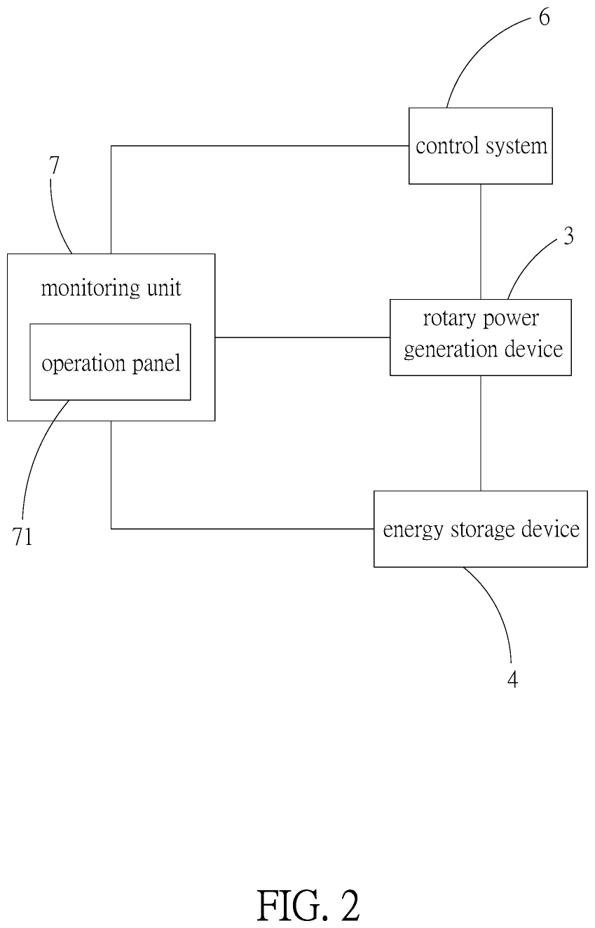

Referring to FIG. 1 and FIG. 2, the present invention provides a system (used in an indoor environment) combining exercise, work, power generation and energy storage. The system is disposed on an exercise apparatus 10. The system comprises a seat 1, a workbench 2, a rotary power generation device 3, an energy storage device 4, a charging port 5, a control system 6, and a monitoring unit 7.

The workbench 2 is located in front of the seat 1. The workbench 2 has a tabletop 21 for the user to work. The workbench 2 may be fixedly or moveably connected to the exercise apparatus 10, so that the user can replace the workbench 2 with a different one.

The rotary power generation device 3 is disposed in the exercise apparats 10 for converting rotational kinetic energy into electric energy. In this embodiment, the exercise apparatus 10 includes two cranks 31. The distal ends of the two cranks 31 are respectively connected to pedals 32 for the user to step on the pedals 32 with his/her both feet. Thus, the user can do exercise on the exercise apparatus 10 by turning the cranks 31 to generate electricity while working.

The energy storage device 4 is electrically connected to the rotary power generation device 3 for storing the electric energy converted by the rotary power generation device 3. In this embodiment, the energy storage device is composed of a battery. The energy storage device 4 is detachably disposed in the exercise apparatus 10. The energy storage device 4 may be built in the exercise apparatus 10 or located outside the exercise apparatus 10, and receives power via the charging port 5 that is disposed on the exercise apparatus 10 or the workbench 2 and electrically connected to the energy storage device 4. The energy storage device 4 is configured to supply the stored power to each device for operation or to supply the stored power to other external devices for use. The charging port 5 may supply power to an electrical product or the energy storage device 4 outside the exercise apparatus 10.

The control system 6 may be disposed on, for example, the exercise apparatus 10, the tabletop 21 or an electronic device. The control system 6 is electrically connected to the rotary power generation device 3. In this embodiment, the control system 6 is disposed on the exercise apparatus 10. The control system 6 may be connected to, for example, a resistor disposed in the exercise apparatus 10 for adjusting its resistance value to set the rotational resistance value of the exercise apparatus 10. The control system 6 converts the rotational resistance value of the exercise apparatus 10 into an estimated power generation datum. When the rotational resistance value is greater, the user needs to apply a stronger force to rotate the exercise apparatus 10, and the estimated power generation data is larger, so as to generate more electric energy.

Specifically, the present invention further comprises a resistor. The resistor is electrically connected to the rotary power generation device 3. (For example, the resistor is disposed in the exercise apparatus 10 and integrated at the rotary power generation device 3.) The control system 6 is electrically connected to the resistor, and the resistance value of the resistor is adjusted by the control system 6 to set the rotational resistance value of the exercise apparatus 10. (The resistance of the resistor may be adjusted by electric power, that is, the resistance may be changed by controlling the current and voltage. Alternatively, the power generator is equipped with an electromagnet, and the electromagnet has the same function as the resistor.)

The rotational resistance value of the exercise apparatus 10 means that if the exercise apparatus 10 is a power generator with a rotating mechanism, the generator may be a simple power generation structure in cooperation with an additional resistor as mentioned above, or the power generation structure is integrated with the resistance function of the electromagnet. That is, the resistance structure may be integrated in the rotary power generation device 3 or provided separately.

The monitoring unit 7 may be disposed on, for example, the exercise apparatus 10, the tabletop 21 or an electronic device. In this embodiment, the monitoring unit 7 is disposed on the tabletop 21, and is electrically connected to the control system 6 via an input port 72 connected to a signal cable (such as VGA, Type-C) for the monitoring unit 7 to adjust the rotational resistance value of the exercise apparatus 10, and to read and record the adjustment data of the resistance and the estimated power generation data. The monitoring unit 7 has an operation panel 71. The energy storage device 4 is electrically connected to the monitoring unit 7 to supply power to the operation panel 71. The operation panel 71 displays the above data for the user, and the rotational resistance value of the exercise apparatus 10 can be adjusted on the operation panel 71.

In addition, the monitoring unit 7 may be connected to the exercise apparatus 10 to read and record the user's exercise data, and connected to the energy storage device 4 to read and record electric energy storage data. The operation panel 71 displays the above data for the user.

Furthermore, the monitoring unit 7 may be an electronic device, such as a mobile phone or a tablet, and is pre-loaded with a program or APP, and is connected to the exercise apparatus 10, the energy storage device 4 and the control system 6 in a wireless or wired manner, so as to read and record the relevant working data of each device.

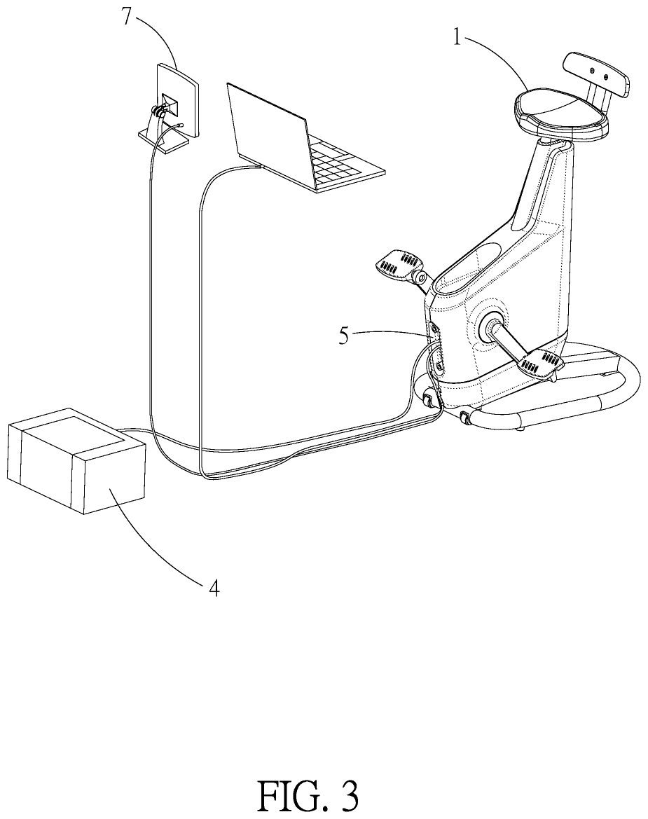

FIG. 3 is another embodiment of the present invention. The electric energy generated by the rotary power generation device 3 can be supplied to the energy storage device 4, the resistor and the electrical product. The monitoring unit 7 can adjust the rotational resistance value through the control system 6 under different connection conditions of the exercise apparatus 10 connected to the energy storage device 4, the resistor, and the electrical product, thereby adjusting the electric energy allocated to each connected object. That is to say, through the charging port 5, the electric energy generated by the rotary power generation device 3 can be connected to the monitoring unit 7, the energy storage device 4 (which may be externally connected to or installed in the exercise apparatus 10), the electrical product (such as a notebook computer), and the resistor. The user can set the rotational resistance by adjusting the resistance value of the resistor through the control system 6, so as to distribute the estimated electric energy generated by the rotational resistance to the monitoring unit 7, the energy storage device 4, the electrical product, and the resistor.

As shown in the system combining exercise, work, power generation and energy storage provided by the present invention, in use, the rotational kinetic energy generated by stepping the exercise apparatus 10 is converted into electric energy by the rotary power generation device 3, and the electric energy is stored in the energy storage device 4. The energy storage device 4 supplies the power required by the monitoring unit 7, allowing the user to read and view various data through the monitoring unit 7. Furthermore, the rotational resistance value of the exercise apparatus 10 can be adjusted through the operation panel 71 to the exercise intensity suitable for the user. The user can do exercise while working. The energy storage device 4 is configured for energy storage and power generation, thereby achieving a management system that integrates the relationship between resistance and power generation, the usage of the stored power and the user's exercise efficiency.

What is claimed is:

1. A system combining exercise, work, power generation and energy storage, disposed on an exercise apparatus, comprising:
a seat;
a workbench, disposed in front of the seat;
a rotary power generation device, disposed in the exercise apparats for converting rotational kinetic energy into electric energy;
an energy storage device, electrically connected to the rotary power generation device for storing the electric energy converted by the rotary power generation device;
a charging port, disposed on the exercise apparats or the workbench;
a monitoring unit, configured to provide an operation interface and display data of the kinetic energy and the electric energy;
a control system, electrically connected to the rotary power generation device, the energy storage device, the charging port, the monitoring unit and a resistor for managing or controlling the electric energy, so as to adjust a charging electric energy demand of the charging port, the electric energy stored by the energy storage device, and a resistance power of the resistor according to a resistance setting value of the monitoring unit.

2. The system as claimed in claim 1, wherein the energy storage device is detachably disposed in the exercise apparatus and receives power through the charging port of the exercise apparatus.

3. The system as claimed in claim 1, wherein the monitoring unit has an operation panel, and the energy storage device is electrically connected to the monitoring unit to supply power to the operation panel for operation.

4. The system as claimed in claim 1, wherein the control system converts a rotational resistance value of the exercise apparatus into an estimated power generation datum.

5. The system as claimed in claim 1, wherein the monitoring unit is connected to the exercise apparatus for reading and recording exercise data, connected to the energy storage device for reading and recording electric energy storage data, and connected to the control system for reading and recording resistance adjustment data and estimated power generation data.

6. The system as claimed in claim 1, wherein the workbench is fixedly or moveably connected to the exercise apparatus.

7. The system as claimed in claim 1, wherein the resistor supplies resistance power and is electrically connected to the rotary power generation device, the control system is electrically connected to the resistor, and a resistance value of the resistor is adjusted by the control system to set a rotational resistance value of the exercise apparatus.
